(19) United States
(12) Patent Application Publication
(10) Pub. No.: US 2009/0202095 A1
(43) Pub. Date: Aug. 13, 2009

(54) SPEAKER DEVICE

(75) Inventors: Hiroshi Yano, Mie (JP); Takeshi Shimokawatoko, Mie (JP); Kazuki Honda, Mie (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/720,375

(22) PCT Filed: Jan. 30, 2006
(86) PCT No.: PCT/JP2006/301424

§ 371 Date: May 29, 2007

(30) Foreign Application Priority Data
Feb. 25, 2005 (JP) 2005-050424

(51) Int. Cl. H04R 1/02; H04R 9/06

(52) U.S. Cl. 381/349; 381/412

(57) ABSTRACT

There is provided a speaker device in which a baffle plate that forms an acoustic space is formed of a resin material, and a step is provided at an opening for fixing a diaphragm in this baffle plate so that the diaphragm is positioned by this step. It is thereby possible to improve strength of the baffle plate and strength of the speaker device.

### TECHNICAL FIELD

The present invention relates to a speaker device, in which a speaker is integrated into a box that forms an acoustic space.

### BACKGROUND ART

Generally, in small-sized electronic equipment such as a mobile phone, a speaker is directly fixed to an exterior box of the small-sized electronic equipment. In the case of further improving acoustic performance of such a speaker, a speaker device has been formed in which the speaker has been housed in a box that forms a prescribed acoustic space, and this speaker device has been fixed to an external box. Such a speaker device is disclosed in Japanese Utility Model Unexamined Publication No. S57-151086.

However, since reduction in size and weight is an important factor for such small electronic instrument, a speaker device used for the instrument is also required to be reduced in size and weight. This has led to adoption of a resin as a lightweight material also for the box that forms the speaker device, and there has been a challenge to secure strength of the speaker device.

### DISCLOSURE OF THE INVENTION

The present invention provides a speaker device having: a speaker including a magnetic circuit, a voice coil driven by the magnetic circuit, and a diaphragm with its inner peripheral end connected to the voice coil; a baffle plate made of a resin and having an opening that connects an outer peripheral end of the diaphragm; and a back cover connected with an outer peripheral end of the baffle plate to cover a back surface side of the speaker and forming a prescribed acoustic space, wherein a step is provided at the opening of the baffle plate, and the diaphragm is positioned by the step. Such a configuration allows improvement in strength of the resin-made baffle plate that forms the acoustic space. This can result in improvement in strength of a small-sized lightweight speaker device.

### BRIEF DESCRIPTION OF THE DRAWINGS

FIG. 1 is a sectional view of a speaker device in one exemplary embodiment of the present invention.

FIG. 2 is a bottom view of an inside of the speaker device shown in FIG.1.

FIG. 3 is a sectional view of another speaker device.

FIG. 4 is a sectional view of still another speaker device.
1 baffle plate
2 opening
3 speaker
4 back cover
5 magnetic circuit
6 voice coil
7 diaphragm
12 acoustic space
13 step
14 bass-reflex port
17 partition wall
18 through hole

### PREFERRED EMBODIMENTS FOR CARRYING OUT THE INVENTION

In the following, one exemplary embodiment of the present invention is described with reference to drawings. The drawings are schematic views, and are thus not views showing positional relationships in a dimensionally accurate manner. Further, the present invention is not limited to the embodiment.

### Embodiment

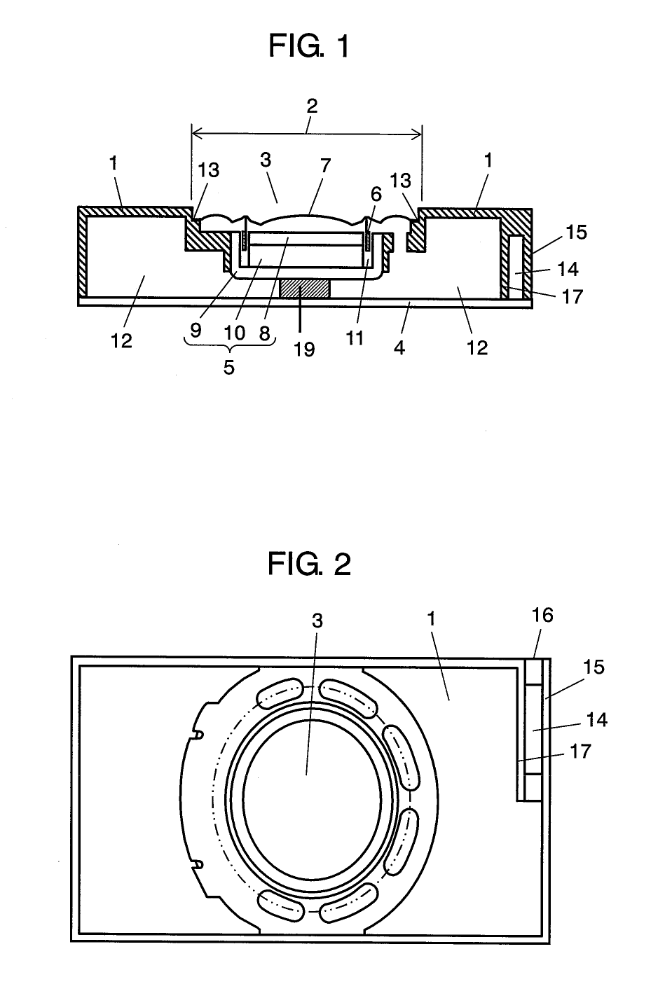

FIG. 1 is a sectional view showing a speaker device of the present invention. A fundamental structure is that speaker 3 is connected to opening 2 of baffle plate 1, and a back surface side of speaker 3 is covered with back cover 4. Speaker 3 is formed of magnetic circuit 5, voice coil 6 and diaphragm 7. Magnetic circuit 5 is configured by arrangement of magnet 10 between upper plate 8 and yoke 9. Voice coil 6 is provided at magnetic gap 11 formed between an extended portion of yoke 9 and upper plate 8. An audio signal is inputted into voice coil 6 to drive voice coil 6. In this structure, diaphragm 7 is vibrated with driving of voice coil 6 to emit a sound.

Further, acoustic space 12 of this speaker device is formed by baffle plate 1 and back cover 4. Each of baffle plate 1 and back cover 4 is a resin formed body, and a tabular central portion of an upper surface of baffle plate 1 is integrated with speaker 3. Baffle plate 1 has opening 2 to be used as a frame of speaker 3. It should be noted that examples of the resin formed body may include polyphthalamide and super-heat resistant ABS. Further, step 13 is provided at a side surface of opening 2 of baffle plate 1. In this structure, diaphragm 7 is positioned by use of step 13 in fixing of diaphragm 7, and magnetic circuit 5 is fixed to a portion extended from step 13. Formation of step 13 in opening 2 of baffle plate 1 leads to formation of a protrusion at a side of acoustic space 12 (i.e. back surface side of speaker 3) of baffle plate 1. This protrusion functions as a rib structure of soft baffle plate 1 formed by resin molding. As thus described, by providing step 13, it is possible to obtain effects of improving an action of positioning diaphragm 7 and strength of baffle plate 1. This can result in improvement in strength of a small-sized lightweight speaker device.

Moreover, it is known that such a speaker device is provided with a bass-reflex port in order to enhance an acoustic characteristic. In the present embodiment, through hole 16 is provided at outer peripheral side wall portion 15 of baffle plate 1, and partition wall 17, which protrudes from through hole 16 along outer peripheral side wall portion 15 so as to come in contact with back cover 4, is provided. As shown in FIG. 2, an acoustic path, which extends from acoustic space 12 formed by partition wall 17 and outer peripheral side wall portion 15 to through hole 16, is configured as bass-reflex port 14. With this configuration, outer peripheral side wall portion 15 and partition wall 17 provided at baffle plate 1 function as a rib structure of the upper surface of soft baffle plate 1 as the resin formed body, to improve the strength of baffle plate 1. This can result in improvement in strength of the small-sized lightweight speaker.

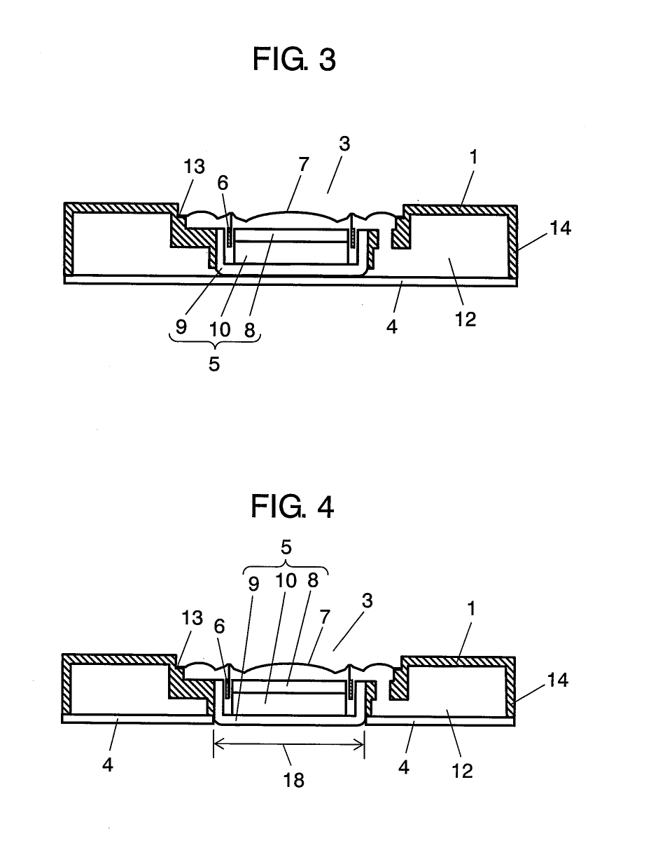

It should be noted that in the speaker device of the present embodiment, buffer member 19 is provided between a bottom surface of magnetic circuit 5 and back cover 4 for suppressing deterioration in acoustic characteristic due to vibrations of speaker 3 itself. For realizing further reduction in height, a structure may be employed as shown in FIG. 3 in which the bottom surface of magnetic circuit 5 is brought into contact with back cover 4. Moreover, as shown in FIG. 4, through hole 18 may be provided at back cover 4 to fit the bottom of magnetic circuit 5 in through hole 18.

### INDUSTRIAL APPLICABILITY

The present invention has an effect of enhancing mechanical strength in a speaker device having been reduced in size and weight. Further, the present invention is effective especially as a speaker device used for small-sized electrical instrument such as a mobile phone.

1. A speaker device comprising:
a speaker having
a magnetic circuit,
a voice coil driven by the magnetic circuit, and
a diaphragm with its inner peripheral end connected to the voice coil;
a baffle plate made of a resin and having an opening that connects an outer peripheral end of the diaphragm; and
a back cover connected with an outer peripheral end of the baffle plate to cover a back surface side of the speaker and forming a prescribed acoustic space,
wherein a step is provided at the opening of the baffle plate, and the diaphragm is positioned by the step.

2. The speaker device according to claim 1,
wherein a partition wall protruding toward the back cover is provided at the baffle plate to form a bass-reflex port inside the acoustic space.

3. The speaker device according to claim 1,
wherein a bottom of the magnetic circuit has been brought into contact with the back cover.

4. The speaker device according to claim 1,
wherein a through hole is provided at the back cover, and the bottom of the magnetic circuit is fitted in the through hole.
